(19) United States
(12) Patent Application Publication
(10) Pub. No.: US 2007/0158627 A1
(43) Pub. Date: Jul. 12, 2007

(54) Motorized lift for electronic display device

(76) Inventors: Jay Dittmer, Prior Lake, MN (US); Paul Smith, Savage, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/649,334

(22) Filed: Jan. 3, 2007

Related U.S. Application Data
(60) Provisional application No. 60/756,069, filed on Jan. 4, 2006.

(51) Int. Cl. B66F 3/00

(52) U.S. Cl. 254/124; 248/157; 187/251

(57) ABSTRACT

A motorized lift for an electronic display includes a reversible electric motor operably coupled to a first shiftable column and a second shiftable column, the coupling to the first column being direct and the coupling to the second column being indirect whereby operation of the electric motor in a first rotational direction acts to simultaneously extend the first and second columns and operation of the electric motor in a second and opposite rotational direction acts to simultaneously retract the first and second columns. A method of operating a motorized lift for an electronic display is further included.

### RELATED APPLICATION

The present application claims the benefit of U.S. Provisional Application Ser. No. 60/756,069, filed Jan. 4, 2006 and incorporated herein in its entirety by reference.

### FIELD OF THE INVENTION

The invention relates to electronic display devices and in particular motorized lifting devices for electronic display devices.

### BACKGROUND OF THE INVENTION

Flat panel electronic display devices are becoming increasingly popular for home use as production increases and prices come down. Especially popular are large flat panel display devices, typically plasma screens, which have enabled a large screen size to be presented in a device of relatively compact volume.

While being generally lighter than CRT devices, flat panel displays in large screen sizes are still relatively heavy for an individual to manage. As a consequence, it is desirable to mount large flat panel display devices on a mounting device that enables an individual to position the device for viewing.

Motorized mounts are particularly desirable since they require the least amount of physical effort for positioning. Prior motorized mounts, particularly vertical lifting devices, however, have generally not been entirely satisfactory in that the motion of the device is typically uneven and somewhat jerky.

What is needed in the industry is a motorized vertical lift for a flat panel display that offers smooth operation.

### SUMMARY OF THE INVENTION

The present invention addresses the aforementioned need in the industry by providing a smooth operating motorized vertical lifting device for a flat panel electronic display. The vertical lifting device incorporates a single drive motor, actuation of the drive motor acting to simultaneously, cooperatively extend two concentric extension columns. In the retracted disposition, the two columns are substantially withdrawn into a casing. When extended, the two columns extend above the casing, a first column extending above the upper margin of a second column. Preferably, the first column extends above the second column a distance that is generally equal to a distance that the second column extends above the casing. The two columns may be positioned at any position intermediate the fully retracted and the fully extended positions so that the height of the flat panel display may set at any desired disposition for viewing.

In an embodiment, the drive motor directly drives a jacking screw drive system operably coupled to the second column and indirectly drives a cable and pulley system that operably couples the first and second columns. Such a drive mechanism smoothly extends and retracts the motorized display of the present invention.

An embodiment of the present invention includes a motorized lift for an electronic display, including a reversible electric motor operably coupled to a first shiftable column and a second shiftable column, the coupling to the first column being direct and the coupling to the second column being indirect whereby operation of the electric motor in a first rotational direction acts to simultaneously extend the first and second columns and operation of the electric motor in a second and opposite rotational direction acts to simultaneously retract the first and second columns. An embodiment of the present invention further include a method of operating a motorized lift for an electronic display.

### BRIEF DESCRIPTION OF THE DRAWINGS

FIG. 1 is a perspective view of a motorized vertical lift for a flat panel electronic display according to an embodiment of the invention;

FIG. 2 is a side elevation view of the lift depicted in FIG. 1 in a fully extended position and with a flat panel display attached;

FIG. 3 is a front elevation view of the list depicted in FIG. 1;

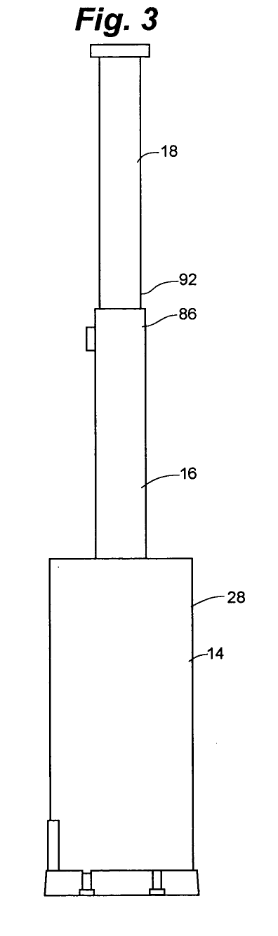

FIG. 4 is a perspective view of the lift of FIG. 1 with the casing removed;

FIG. 5 is a front elevation view of the lift of FIG. 1 with the casing and lower extension column removed to expose the drive mechanism of the device;

FIG. 6 is a fragmentary perspective view of a portion of the drive mechanism of a lift according to an embodiment of the invention;

FIG. 7 is a fragmentary bottom perspective view of a portion of the drive mechanism of a lift according to an embodiment of the invention;

FIG. 8 is fragmentary top perspective view of another portion of the drive mechanism of a lift according to an embodiment of the invention; and

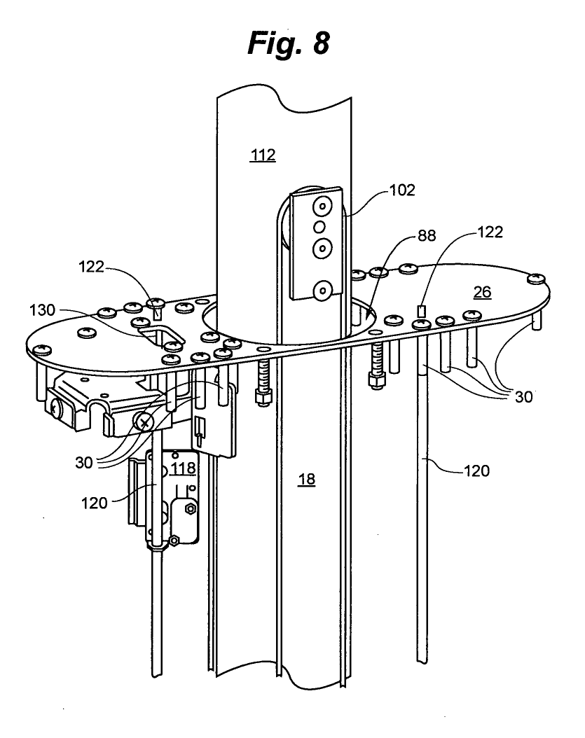

FIG. 9 is a perspective view of the lift of FIG. 1 with the casing and lower extension column removed to expose the drive mechanism of the device.

### DETAILED DESCRIPTION OF THE PREFERRED EMBODIMENTS

Motorized lift of the present invention is depicted generally at 10 in the figures. The motorized display lift 10 generally includes the following major components: base 12, housing 14, lower extension column 16, upper extension column 18, display mounting bracket 20, and drive mechanism 22.

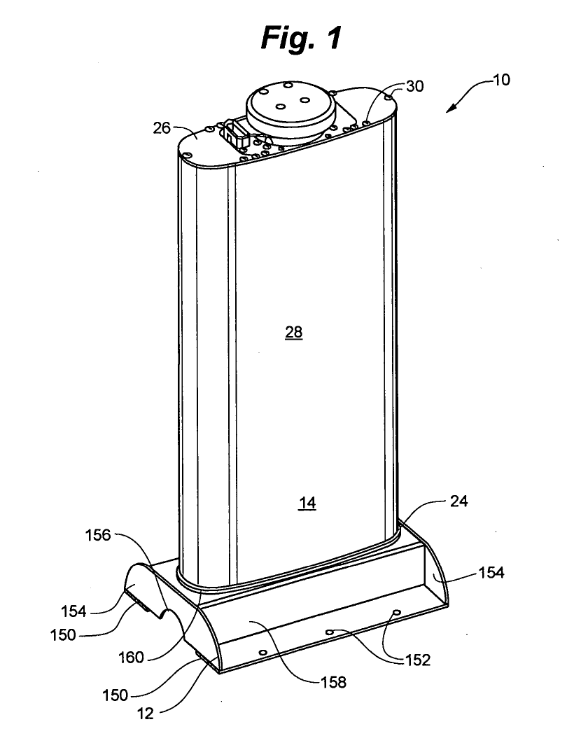

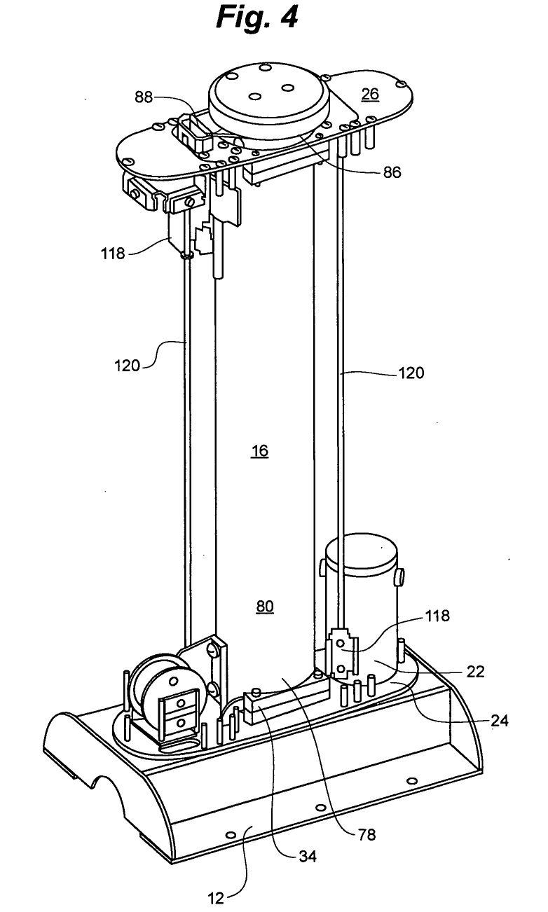

Base 12 of the motorized lift 10, as depicted in FIGS. 1 and 4, includes a pair of spaced apart, parallel mount plates 150. A plurality of mount bores are defined in the mount plates for fasteners that can fixedly mount the motorized display lift 10 to an underlying surface, such as the surface of a cabinet. A pair of spaced apart end plates 154 are fixedly coupled to the respective mount plates 150. An aperture 156 may be defined in the respective end plates 154. A pair of spaced apart, parallel vertical support plates 158 are fixedly coupled to the mount plates 150 and the end plates 154. A horizontal support plate 160 is fixedly coupled to the upper margins of the respective vertical support plates 158 and the end plates 154. An interior space is defined beneath the horizontal support plate 160 in which drive components can be mounted as detailed below. A plurality of apertures are defined in the horizontal support plate 160 for accommodating such mounting.

The second component of the motorized lift 10 is the housing 14, as depicted in FIG. 1. Housing 14 generally includes bottom plate 24, top plate 26, and casing 28, fastened together with fasteners 30. The bottom plate 24 and top plate 26 each have suitable apertures defied therein for accommodating the passage of mechanical components therethrough. The inner margin of the casing 28 is preferably formed of a smooth finish in order to minimize the buildup of friction forces with the passage of bearings along the surface of the inner margin, as detailed below.

The third component of the motorized lift 10 is the drive mechanism 22, as depicted in FIGS. 4-7 and 9. Drive mechanism 22 generally includes the following subcomponents: drive train assembly 32, lower platform 34, upper platform 36, cable and pulley rigging 38, and display cable management assembly 40.

Drive train assembly 32 of the drive mechanism 22 generally includes motor 42, drive sheave 44, drive belt 46, sheave 48, jacking screw 50, and nut 52. Motor 42 is mounted on bottom plate 24 with output shaft 54 depending therefrom and extending through an aperture defined in the bottom plate 24 and a corresponding aperture defined in the horizontal support plate 160 of the base 12. Drive sheave 44 is received on output shaft 54 and is driveably coupled to driven sheave 48 through drive belt 46. Tensioner 56 having a positionally adjustable pulley 57 the bears on the outer margin of the drive belt 46 may be provided to maintain proper tension and alleviate slack in drive belt 46.

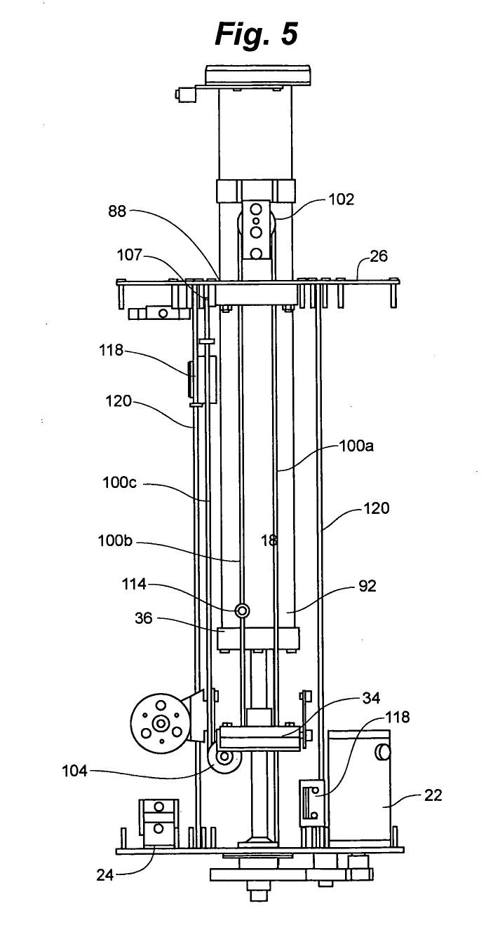

Jacking screw 50 (see particularly FIGS. 5-7) extends through an aperture defined in the bottom plate 24 and a corresponding aperture defined in the horizontal support plate 160 of the base 12. Bearing 58, mounted in bottom plate 24, rotatably supports the jacking screw 50. End portion 60 of the jacking screw 50 projects below the horizontal support plate 160 and receives sheave 48 thereon. End portion 60 of jacking screw 50 has threaded portion 62 which receives nut 64 to fixedly retain sheave 48 on jacking screw 50.

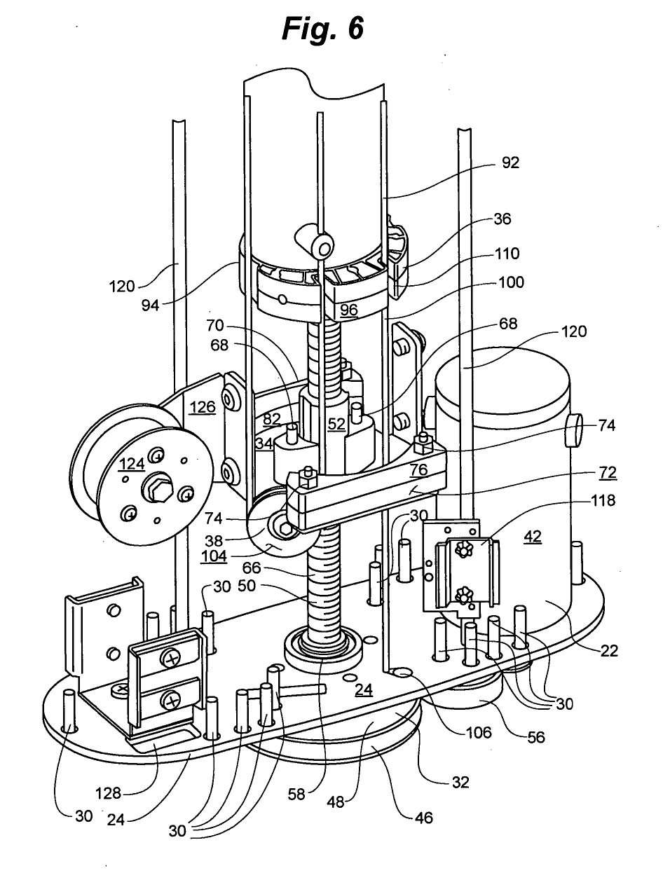

Referring to FIG. 6, jacking screw 50 has spiral thread 66 which engages interior threads provided in jacking nut 52 so that jacking nut 52 is threaded on screw 50. Nut 52 is fixed to lower platform 34 with bolts 68. Slide bearings 70, 72, are attached on each side of lower platform 34 with bolts 74, and positioned so that outer surface 76 is slidably in contact with the inner margin of casing 28. Jacking nut 52 is rotationally constrained by the contact of the slide bearings 70, 72, with the inner margin of casing 28. In this manner, the jacking nut 52 is selectively caused to move upward or downward with the respective clockwise or counterclockwise rotation of the jacking screw 50. Advantageously, slide bearings 70, 72, may be made from a low friction material such as Delrin®.

As depicted in FIG. 4, lower extension column 16 is generally cylindrical. In the depicted retracted disposition, lower extension column 16 is positioned with lower end 78 resting on lower platform 34 and the lower end portion of outer surface 80 contacting the curved inner surface 82 of slide bearings 70, 72. Jacking screw 50 is received generally coaxially through hollow interior 84 of lower extension column 16. Upper end 86 of lower extension column 16 projects upward through aperture 88 defined in top plate 26.

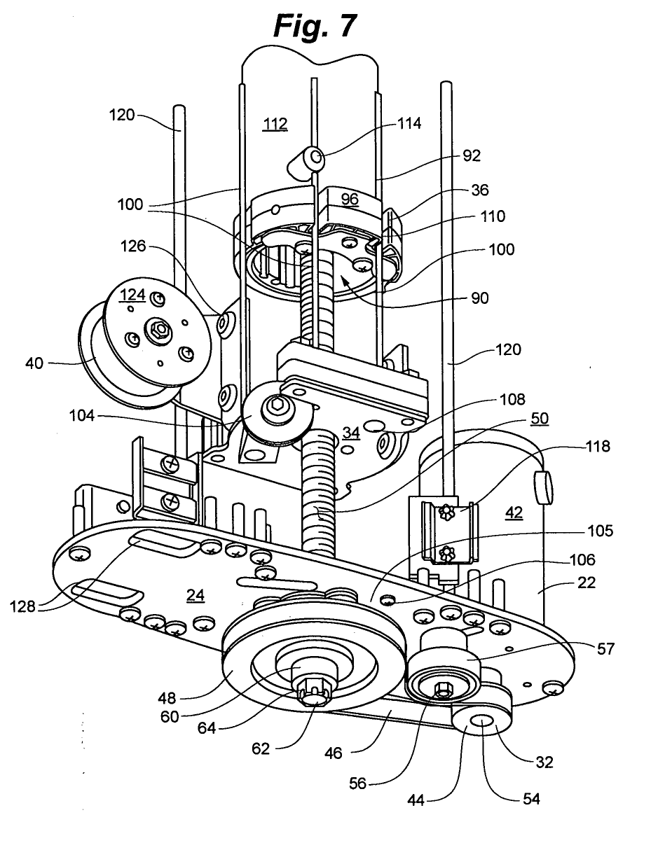

Upper platform 36 (see FIGS. 6 and 7) is generally cylindrical in shape and defines aperture 90, through which jacking screw 50 is generally coaxially received. Jacking screw passes through the aperture 90 without threadedly engaging the upper platform 36. Lower end 92 of upper extension column 18 is received between slide bearings 94, 96, and rests on upper platform 36 when upper extension column 18 is in the retracted disposition. Slide bearings 94, 96, which again may be made from a low friction material such as Delrin®, are positioned so as to be in contact with inner surface 98 of lower extension column 16. Like lower extension column 16, upper extension column 18 is also hollow so that screw 50 in received therein.

Rigging 38 (see FIGS. 5-7, and 9) is the fourth component of the motorized lift 10 and generally includes cable 100, upper pulley 102, and lower pulley 104. Cable 100 is one continuous cable, but for clarity is described in three portions 100a, 100b, and 100c. These three portions of cable 100 are depicted best in FIG. 5. Cable 100a is fixed at a first end 105 to bottom plate 24 at aperture 106. From aperture 106, cable 100a extends upwardly through aperture 108 in lower platform 34 without engaging lower platform 34 and thence through slot 110 in slide bearing 94, again without engaging slide bearing 94. From there, cable 100a extends to upper pulley 102. Upper pulley 102 is rotatably attached to interior surface of lower extension column 16 proximate the upper margin of lower extension column 16. Cable 100a is reeved around upper pulley 102. From thence, cable 100b extends downwardly to pin 114. From pin 114, cable 100b extends further downward to lower pulley 104 and is reeved around lower pulley 104. The two portions 100a, 100b of cable 100 so far described are generally parallel to one another, the first portion ascending to upper pulley 102 and the second descending to lower pulley 104. Lower pulley 104 is rotatably attached to lower platform 34, lower platform 34 being affixed to lower column 16. Accordingly, both of the pulleys 102, 104 are coupled to lower column 16. See FIG. 7. After passing around lower pulley 104, cable 100c extends upward and the second end 107 of cable 100 is fixed to top plate 26. Cable portion 100c is likewise generally parallel to cable portions 100a and 100b. Neither top plate 26 nor bottom plate 24 is moveable during extension or retraction of the two columns 16, 18. In distinction, both pulleys 102, 104 translate upward and downward during respective extension and retraction of the two columns 16, 18.

Significantly, it is at pin 114 that cable 100 is fixedly coupled to upper extension column 18. Such coupling makes the length of cable 100 between pin 114 and first end 105 fixed in length and makes the length of cable 100 between pin 114 and second end 107 fixed in length. With upward motion of the lower extension column 16, the length of cable 100 between pin 114 and first end 105 acts to positively pull upper extension column 18 upward, thereby extending upper extension column 18. Conversely, with downward motion of the lower extension column 16, the length of cable 100 between pin 114 and second end 107 acts to positively pull upper extension column 18 downward, thereby retracting upper extension column 18. By fixing the two lengths of cable 100 at pin 114, upper extension column 18 can be positively extended, positively retracted and positively held in any position between full retraction and full extension as a function of the position of the lower extension column 16. As noted above, the lower extension column 16 is directly shiftably coupled to the motor 42 of the drive mechanism 22. Since upper extension column 18 is coupled to lower extension column 16, upper extension column 18 is indirectly shiftably coupled to the motor 42 of the drive mechanism 22. Actuation of motor 42 of the drive mechanism 22 therefore acts to simultaneously translatably shift both the lower extension column 16 and the upper extension column 18.

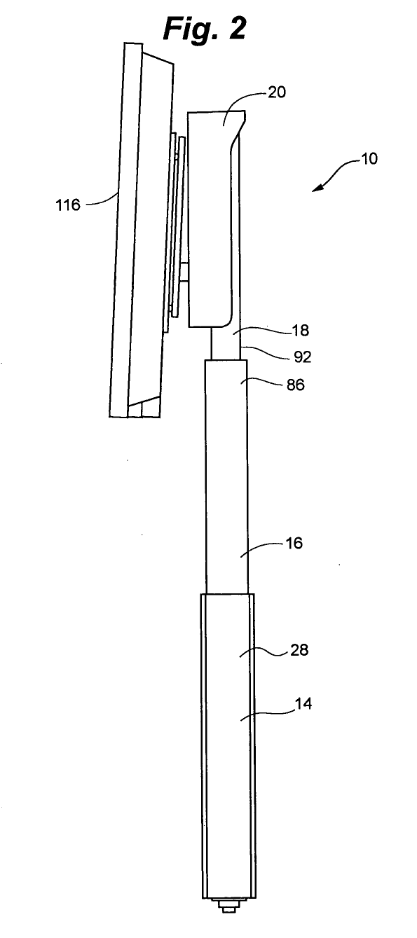

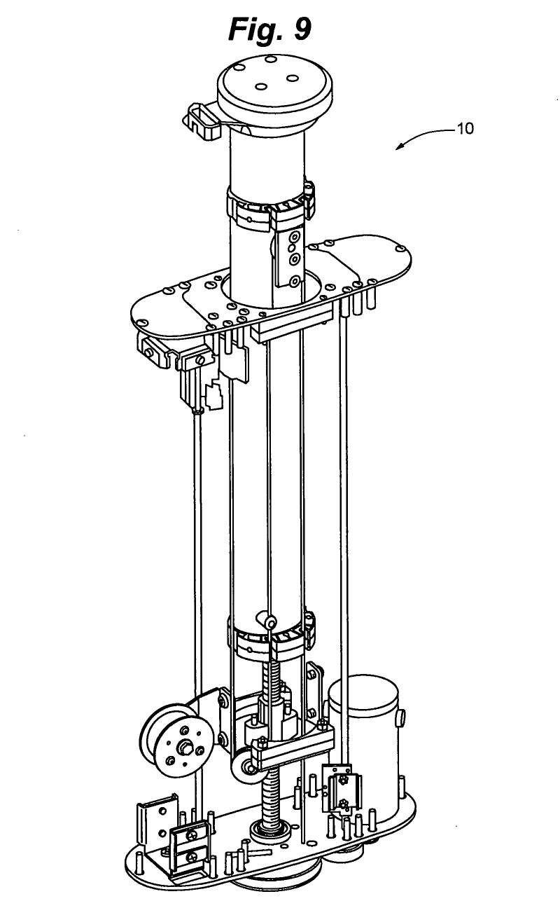

In extending operation, with the motorized lift 10 in the fully retracted position depicted in FIGS. 1 and 9, motor 42 rotates drive sheave 44, in turn rotating driven sheave 48 and jacking screw 50 by means of drive belt 46. As jacking screw 50 rotates, jacking nut 52 is constrained from rotating by sliding contact with the inner margin of the casing 28. Accordingly, jacking screw 50 is threaded upwardly along screw 50, causing lower platform 34 to move upwardly relative to bottom plate 24 and thereby extending lower extension column 16 upwardly through aperture 88 in top plate 26. As lower extension column 16 moves upward elevating the pulley 102 of the rigging 38, rigging 38 causes upper extension column 18 to be pulled upward relative to the lower extension column 16 and simultaneously extends from upper end 86 of lower extension column 16 until the motorized lift 10 reaches the fully extended position depicted in FIG. 2. Preferably, rigging 38 is arranged so that the rate of extension of lower extension column 16 from top plate 26 and the rate of extension of upper extension column 18 from lower extension column 16 are approximately equal, lending the mechanism a smooth operating appearance. Coordinating the rates of extension of the columns 16, 18 is effected by the relative diametric sizing of the two pulleys 102, 104. In a preferred embodiment, the diameter of pulley 102 is generally twice that of pulley 104.

When the rotation of motor 42 is reversed, the mechanism operates in a similar fashion to retract lower extension column 16 and upper extension column 18 within housing 28. As lower extension column 16 moves downward lowering the pulley 104 of the rigging 38, rigging 38 causes upper extension column 18 to be pulled downward relative to the lower extension column 16. An electronic display device 116 attached to upper extension column 18 with display mounting bracket 20 may thus be vertically raised and lowered with the motorized display lift 10.

Motor 42 may be turned on and off at the travel limits of the mechanism with limit switches 118 mounted on threaded rod 120. The position of limit switches 118 may be adjusted from outside the device by turning end 122 of threaded rod 120, which projects through top plate 26. Alternatively, a manual switch may be electrically communicatively coupled to the motor 42 and the columns 16, 18 mat be manually stopped at any desired disposition between the fully extended and fully retracted dispositions.

Cable management assembly 40 generally includes pulley 124 which is rotatably mounted to lower platform 34 with bracket 126. Cables, such as power and video signal cables for the flat panel display may be routed through aperture 128 in bottom plate 24 and upward through casing 28 where they are clipped to top plate 26. The cables then extend downwardly to loop around pulley 124 before extending upwardly again through aperture 130 in top plate 26. As the lift is operated, pulley 124 takes up any slack in the cables, thereby preventing binding and tangling of cables inside casing 28.

What is claimed is:

1. A motorized lift for an electronic display, comprising:
a reversible electric motor operably coupled to a first shiftable column and a second shiftable column, the coupling to the first column being direct and the coupling to the second column being indirect whereby operation of the electric motor in a first rotational direction acts to simultaneously extend the first and second columns and operation of the electric motor in a second and opposite rotational direction acts to simultaneously retract the first and second columns.

2. The lift of claim 1, the second column being operably actuatably coupled to the first column.

3. The lift of claim 1, wherein actuation of the first column acts to actuate the second column.

4. The lift of claim 1, wherein the second column extends from and retracts into the first column.

5. The lift of claim 1, wherein second column is operably actuatably coupled to the first column by means of a pulley and cable device.

6. The lift of claim 5, wherein a first pulley and a second pulley of the pulley and cable device are operably coupled to the first column, a cable being reeved around both the first and second pulleys and fixedly coupled to the second column.

7. The lift of claim 1, the first column being operably actuatably coupled to the motor by means of a jacking screw threadedly engaged with a jacking nut.

8. The lift of claim 7, wherein rotation of the jacking screw in a first direction acts to cause the jacking nut to elevate relative to the jacking screw and rotation of the jacking screw in a second direction acts to cause the jacking nut to descend relative to the jacking screw.

9. The lift of claim 1 further including a housing wherein actuation of the first and second columns causes the second column to shift relative to the first column at a rate that is substantially equal to the rate of shift of the first column relative to the housing.

10. The lift of claim 1 wherein the first and second columns are coaxially disposed.

11. The lift of claim 10 wherein a jacking screw is coaxially disposed with the first and second columns.

12. A motorized lift for an electronic display, comprising:
a first shiftable column and a second shiftable column being coaxially disposed, the second column being received within the first column when in a retracted disposition and extended relative to the first column when in an extended disposition.

13. The lift of claim 12, the first shiftable column and the second shiftable column being retracted substantially within a housing when in the retracted disposition.

14. The lift of claim 13, the first shiftable column and the second shiftable column being extended relative to the housing when in the extended disposition.

15. The lift of claim 12, the first shiftable column being operably coupled to the second shiftable column such that shifting actuation of the first column acts to shift the second column relative to the first column.

16. The lift of claim 12, wherein second column is operably actuatably coupled to the first column by means of a pulley and cable device.

17. The lift of claim 12, the first column being operably actuatably coupled to a reversible motor by means of a jacking screw threadedly engaged with a jacking nut.

18. A method of operating a motorized lift for an electronic display, comprising:
selectively simultaneously extending a first and a second column, the second column extending relative to the first column and simultaneously retracting the first and second columns, the second column being retracted into the first column.

19. The method of claim 18, including operably actuatably coupling the second column to the first column.

20. The method of claim 18, including actuating the second column by means of actuation of the first column.
